(19) United States
(12) Patent Application Publication
(10) Pub. No.: US 2013/0173327 A1
(43) Pub. Date: Jul. 4, 2013

(54) PROJECT MANAGEMENT SYSTEM AND METHOD

(71) Applicants: Angel Lance, Penngrove, CA (US); David Luper, San Francisco, CA (US); Nicholas Haigh, Lawrenceville, NJ (US)

(72) Inventors: Angel Lance, Penngrove, CA (US); David Luper, San Francisco, CA (US); Nicholas Haigh, Lawrenceville, NJ (US)

(21) Appl. No.: 13/339,305

(22) Filed: Dec. 28, 2011

(51) Int. Cl. G06Q 10/06

(52) U.S. Cl. 705/7.23; 705/7.28; 705/7.41

(57) ABSTRACT

Systems and methods for providing project management tools and instructions are disclosed. The systems and methods generally include: (a) performing an initial assessment to determine a pre-existing project management status for a plurality of project management parameters; (b) establishing a substantially equivalent quality level for the project management parameters based on the initial assessment; (c) creating an implementation plan including instructions for implementing a plurality of the project management parameters at the substantially equivalent quality level; and (d) providing training materials based on the implementation plan.

### SUMMARY

Disclosed herein are systems and methods for providing project management tools and instructions. In one embodiment, the systems and methods are used for the coordination and management of one-time projects (or procedures) undertaken by an entity. The presented project management systems and methods generally include: (a) performing an initial assessment to determine a pre-existing project management status for a plurality of project management parameters; (b) establishing a substantially equivalent quality level for the project management parameters based on the initial assessment; (c) creating an implementation plan including instructions for implementing a plurality of the project management parameters at the substantially equivalent quality level; and (d) providing training materials based on the implementation plan. The project management parameters may include one or more of the following parameters: (1) communications management, (2) financial management, (3) integration management, (4) issue and risk management, (5) metrics and reporting management, (6) resource management, (7) scope and change control management, (8) stakeholder management, (9) tool support management, and (10) work planning management. In one embodiment, the initial assessment is performed on all ten project management parameters, with the objective of ensuring a substantially equivalent quality level is met across all ten project management parameters.

### BRIEF DESCRIPTION OF THE FIGURES

The accompanying drawings, which are incorporated herein, form part of the specification. Together with this written description, the drawings further serve to explain the principles of, and to enable a person skilled in the relevant art(s), to make and use the claimed systems and methods.

FIG. 1 is a high-level schematic of a project management process.

FIG. 2 is a high-level flowchart illustrating one embodiment presented herein.

FIG. 3 is a flowchart illustrating another embodiment presented herein.

FIG. 4 is a flowchart illustrating yet another embodiment presented herein.

FIG. 5 is a schematic drawing of a computer system used to implement the methods and systems presented.

### DETAILED DESCRIPTION

Disclosed herein are systems and methods for providing project management tools and instructions. In one embodiment, the systems and methods are used for the coordination and management of one-time projects (or procedures) undertaken by an entity. The presented project management systems and methods generally include: (a) performing an initial assessment to determine a pre-existing project management status for a plurality of project management parameters; (b) establishing a substantially equivalent quality level for the project management parameters based on the initial assessment; (c) creating an implementation plan including instructions for implementing a plurality of the project management parameters at the substantially equivalent quality level; and (d) providing training materials based on the implementation plan. The project management parameters may include one or more of the following parameters: (1) communications management, (2) financial management, (3) integration management, (4) issue and risk management, (5) metrics and reporting management, (6) resource management, (7) scope and change control management, (8) stakeholder management, (9) tool support management, (10) work planning management, and any equivalents or combinations thereof. In one embodiment, the initial assessment is performed on the ten listed project management parameters, with the objective of ensuring a substantially equivalent quality level is met across all ten project management parameters.

The following detailed description of the figures refers to the accompanying drawings that illustrate exemplary embodiments. It is to be understood that this invention is not limited to particular embodiments described, or the particular terminology used herein. Other embodiments and terminology are possible. Modifications may be made to the embodiments described herein without departing from the spirit and scope of the present invention. Therefore, the following detailed description is not meant to be limiting. The scope of the present invention will be limited only by the appended claims.

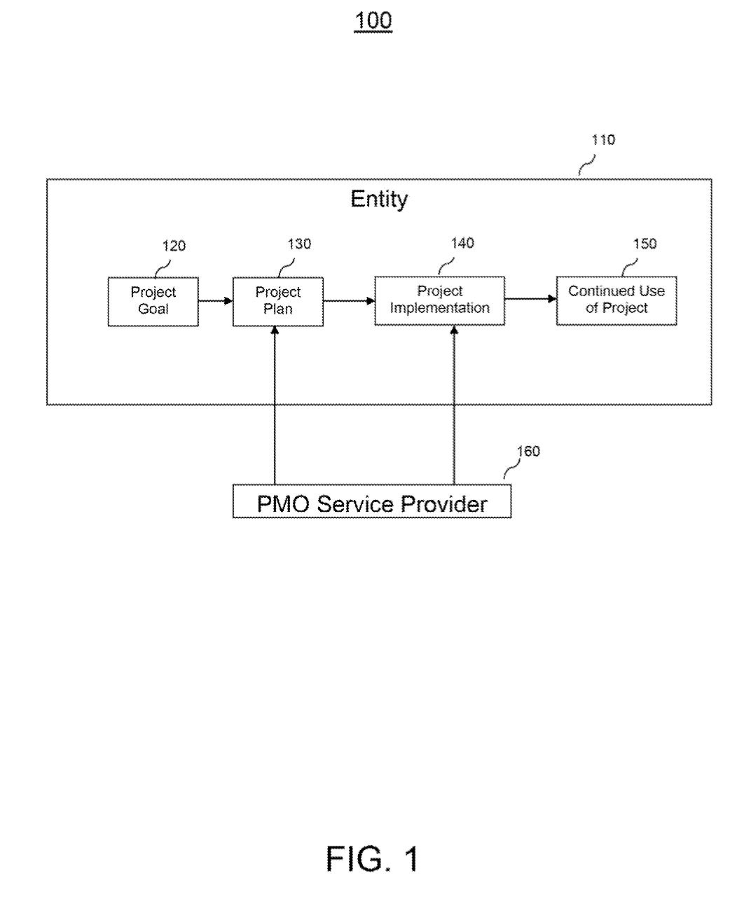

FIG. 1 is a high-level schematic of a project management process 100. As illustrated in FIG. 1, an entity 110 (e.g., a corporation, organization, etc.) performing a project (or procedure) typically undergoes the processes of identifying project goals 120, developing a project plan 130, implementing the project plan 140, and maintaining continued use of the finished project 150. In instances wherein the project is a one-off procedure, or an otherwise unique project outside of the scope of the entity's core competence, entity 110 may decide to seek the support of a Project Management Office (PMO) Service Provider 160. One example of a project, in which the presented systems and methods may be deemed useful, is the deployment of a software package within a large organization, such as the upgrading of reservation software at an airline. Clearly the deployment of a software package is not the airline's core competence, nor is such deployment a typical or recurring project for the airline. As such, proper management of the project is necessary to ensure that the project is completed effectively.

In the planning, implementation, and use of said projects, entity 110 may benefit from centralizing repeatable parts of the project governance work. As such, PMO Service Provider 160 may serve the function(s) of administering, managing, monitoring, and/or measuring (rather than doing) the project. In the embodiment shown, PMO Service Provider 160 may provide input and support in the project planning (i.e., assessment) phase 130 and/or project implementation phase 140. Additionally, PMO Service Provider 160 may also provide input and support in the identification of project goals 120 and/or the continued use of the project 150.

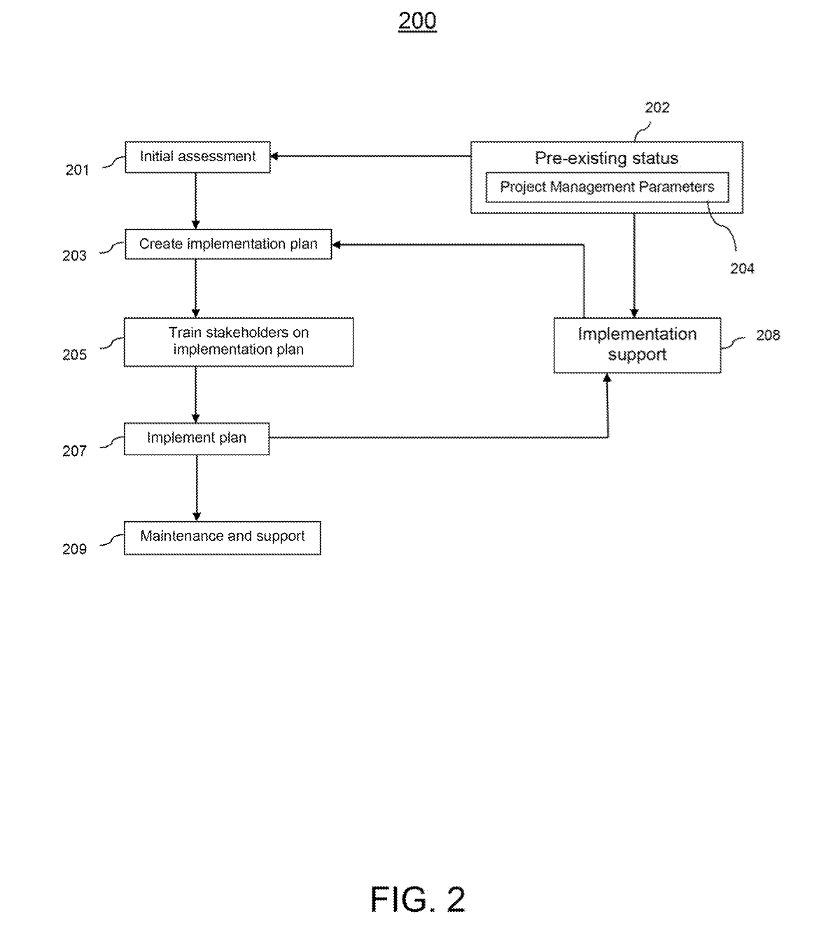

FIG. 2 is a high-level flowchart illustrating one embodiment presented herein. More specifically, FIG. 2 shows a project management method 200. In step 201, an initial assessment is performed to determine a pre-existing project management status. For example, pre-existing data 202 is gathered for the initial assessment. Such pre-existing data may include data on the status and/or planning of one or more project management parameters 204. The project management parameters (discussed further below) may include one or more of the following parameters: (1) communications management, (2) financial management, (3) integration management, (4) issue and risk management, (5) metrics and reporting management, (6) resource management, (7) scope and change control management, (8) stakeholder management, (9) tool support management, (10) work planning management, and any equivalents or combinations thereof.

Conducting an initial assessment allows PMO Service Provider 160 to, for example: develop a baseline of the current state of the project; define what needs to be done during an implementation phase; identify and analyze available resources; and/or perform a risk analysis of the state of the project. The initial assessment may be conducted by various means, such as: a question-and-answer session to draw out data on what is currently planned or in progress; a questionnaire; standardized interview decks; an input-interface or prompt on a computerized system; and/or equivalents or combinations thereof. The initial assessment also allows PMO Service Provider 160 to determine an optimal level of detail for which the project should be managed. In other words, the initial assessment is used to establish and quantify a substantially equivalent quality level for the enumerated project management parameters. As used herein, the term “substantially equivalent quality level” means “sufficiently equivalent to be functionally effective” such as a formal, repeatable process, and application of tools, that is consistently applied. In one embodiment, for example, the quality level for each project management parameter can be tiered and/or scaled in order to define the quality level across project management parameters.

In step 203, an implementation plan is created. The implementation plan may include instructions for implementing a plurality of the project management parameters at the substantially equivalent quality level. For example, the implementation plan may include instructions for effectively running all of the above-enumerated project management parameters. In alternative embodiments, the implementation plan may include only a select number of project management parameters. For example, the implementation plan may include instructions for implementing the project management parameters of: metrics and reporting; work planning; communication management; and/or stake holder management. In other words, during the initial assessment, the ten project management parameters are analyzed to determine the existing quality level of each of the parameters. When creating the implementation plan, instructions are developed to bring all ten of the project management parameters up to the same quality level.

In step 205, the stakeholders (e.g., the entity, the project managers, the parties implementing the project, etc.) are trained on the implementation plan. As used herein, the terms “training,” “providing training materials,” “displaying training materials,” and like phrases, are intended to broadly include any means for distributing or otherwise providing information and/or instructions to the stakeholders. Such means include reports, graphs, displays, monitors, booklets, presentations, computerized data transmission, application programming interfaces for transmitting data and/or instructions, audio/visual prompts, and equivalents and/or combinations thereof.

In step 207, the implementation plan is implemented by the stakeholders. During implementation, implementation support 208 is conducted to ensure continued compliance with the implementation plan. For example, implementation data may be collected by and/or from multiple sources to identify and analyze how each project management parameter is being implemented. In other words, each project management parameter 204 is further analyzed during the implementation phase to determine whether said parameter meets the substantially equivalent quality level. If necessary, the implementation support data may be used to adjust the implementation plan, if one or more of the project management parameters fail(s) to meet the substantially equivalent quality level. Training materials on the adjusted implementation plan may then be provided to the stakeholders.

In step 209, maintenance and support of the project is provided in the form of instructions given to the entity 110 for continued use of the completed project. In the maintenance and support step 209, the vital support roles and remaining PMO structure are set up to ensure proper project and program management in the on-going support of the end project goals. The structure is also set up for the maintenance necessary to ensure upkeep of programs and procedures created during the planning and/or implementation of the project.

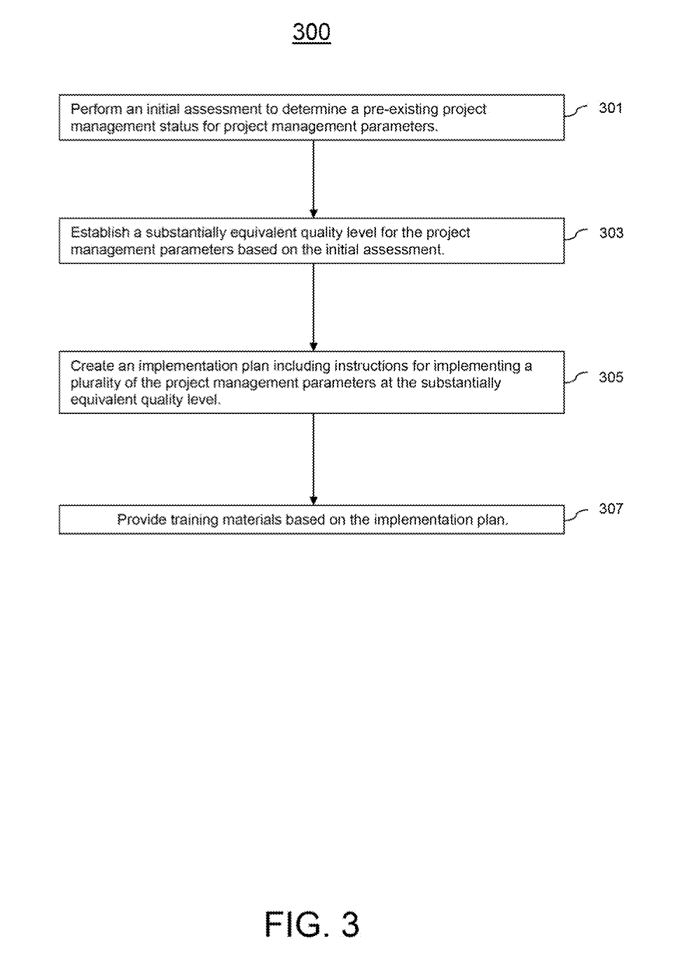

FIG. 3 is a flowchart illustrating another embodiment of a project management method 300. In step 301, an initial assessment is performed to determine a pre-existing project management status for project management parameters. In step 303, a substantially equivalent quality level is established for the project management parameters based on the initial assessment. In step 305, an implementation plan is created, including instructions for implementing a plurality of the project management parameters at the substantially equivalent quality level. In step 307, training materials are provided based on the implementation plan.

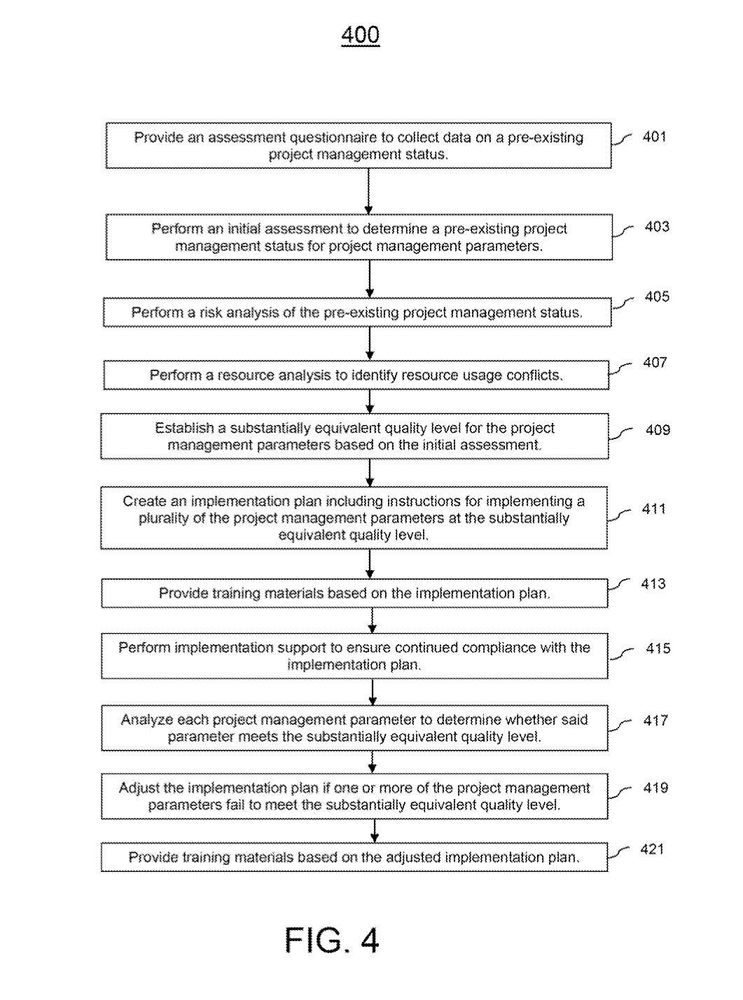

FIG. 4 is a flowchart illustrating yet another embodiment of a project management method 400. In step 401, an assessment questionnaire is provided to the stakeholders to collect data on a pre-existing project management status. An initial assessment is then performed, in step 403, to determine a pre-existing project management status for one or more project management parameters. In step 405, a risk analysis is performed of the pre-existing project management status. A resource analysis is performed, in step 407, to identify resource usage conflicts. Based on the initial assessment, the risk analysis, and/or the resource analysis, a substantially equivalent quality level for the project management parameters is established, in step 409. In step 411, an implementation plan is created, including instructions for implementing a plurality of the project management parameters at the substantially equivalent quality level.

After creation of the implementation plan, training materials are provided to the stakeholders, in step 413. The implementation plan may then be implemented after the instructions of the implementation plan have been distributed. In step 415, implementation support is performed to ensure continued compliance with the implementation plan. In step 417, each project management parameter is analyzed to determine whether said parameter meets the substantially equivalent quality level. In step 419, if necessary, the implementation plan is adjusted if one or more of the project management parameters fail to meet the substantially equivalent quality level. In step 421, the training materials are provided based on the adjusted implementation plan.

### Explanation of Project Management Parameters.

The communications management project management parameter is intended to coordinate communications between the project stakeholders. Communication management is the organized fashion by which a program informs all program stakeholders of the health of the project. Communications management is also the clear, concise, and targeted scheduling of communication distribution. In other words, communications management identifies how to get the right information to the right stakeholder(s), while providing and managing the vehicle for dissemination of information.

Financial management is the process of tracking project costs, including factors such as: human resource costs, material costs, and the costs of other resources. Financial management and tracking generally begins when the project is initially estimated, and continues through and after the project has been completed. Financial managements helps ensure accurate return on investment and/or benefits realization. Financial management also helps provided clarity on project estimated budgets, current spend, future spend, and/or targeted spend. Financial management also provides a reporting function; such as, reporting costs of resources, reporting expenses and costs, and reporting the measurement of the return on investment and the benefit realization.

Integration management is the practice of connecting and tracking important elements across projects to achieve the end program goal. Integration management may include items that are external to the projects/programs, as well as future projects not yet initiated. The objectives of integration management are to provide: clear communication on integration points; accurate tracking of inter-connections; identification of external components for integration; regular and continual impact analysis; and/or tracking and managing how stakeholders, resources, and processes affect each other.

Issue and risk management is the practice of managing problems that come up, or might come up, in a project. “Risks” are generally things, which may happen that could have an impact on the ability to deliver the project. Risk management addresses those problems that have not yet occurred, but are likely to occur. “Issues” are things that have happened. Issue management addresses those problems that have already presented themselves, and barriers to progress. The objectives of issue and risk management is to provide: proactive action planning for problems that might come up; clear commination on problems that could impact timelines, should they arise; prioritization on problems that can derail project progress; standardized language for communication on problems; and/or standardized procedures for capturing and tracking problems that are in progress and are being managed. Issue and risk management may also include the creation of a process flow of re-diverting resources to deal with risk, and detailed process for management of issues.

Metrics and reporting management provides indications of the progress and health of a project. Metrics and reporting management may also identify trends, the causes and effects of various processes in the project, and other important data during the lifecycle of the project. The objectives of metrics and reporting management is to provide: regular quantitative analysis on project health; centralized data; predictive feeds; minor analysis; measurement of variables such as cost, efficiency, risk profile reduction, changes, budget; and standardized reports against programs to articulate health of program.

Resource management includes planning of when/where resources will be staffed on projects (e.g., capacity planning). Resource management also includes the processes and procedures required to roll-off a resource from a project once the function of the resource is completed. Resource management may also include administrative functions such as orientation training, tool access set up, etc. The objective of resource management is to provide: effective capacity management; proactive setup for on/off boarding; clear communication/notification of staffing changes to all stakeholders; resource financial analysis; management of stakeholders; supply/demand on people and resources; and/or proper interaction with work planning management.

Scope and change control management is the act of ensuring the project team is working on the right elements of the project, even as those elements change throughout the project lifecycle. In other words, scope and change control management manages the changes within a project during the project's lifecycle. Scope and change control management allows the PMO Service Provider to have a good handle on what is being changed during the project. The objective of scope and change control management is to provide clear communications to all necessary parties when a project element has officially shifted, and accurate tracking of project components.

Stakeholder management is the practice of keeping those who are impacted by the program informed on the program. The objectives of stakeholder management is to provide: accurate identification of those impacted by the program; consistent communication to those impacted; proactive solicitation of input for problem resolution; understanding of who the stakeholders are, and making sure they are being given the right information at the right time; proper planning to give the right inputs at the right time to the right people; and/or details of what information needs to be given to the right resource.

Tool support management is the incorporation of enterprise project management software specialists to assist in the configuration, adaptation, or development of systems to manage programs. Tool support management provides the standard sets of configurations and setups that are needed in order to facilitate the ongoing project processes.

Work planning management is the process of inputting general estimates into a dynamic resource and scheduling tool, allowing for the creation of organized work break down structures, aligned resource assignments, and rationalized timelines. In other words, work planning management allows for a proper understanding of the project work schedule. Work planning management establishes a timeline of the work that needs to be done, and dynamically brings together the work needs with the resources to be applied, and the challenges to meet the schedule. The objectives of work planning management are to: organize work into manageable packages; sequence work according to how it will be done; align resource estimates with how the work fits on the calendar timeline; view resource gaps; define overall and subset timelines; baseline original scope and associated estimates; and/or track detailed progress once project is in flight.

### Additional Embodiments.

In another embodiment, there is provided a project management method, comprising: (a) performing an initial assessment to determine a pre-existing project management status for project management parameters, wherein the project management parameters include: communications management, financial management, integration management, issue and risk management, metrics and reporting management, resource management, scope and change control management, stakeholder management, tool support management, and work planning management; (b) establishing a substantially equivalent quality level for the project management parameters based on the initial assessment; (c) creating an implementation plan including instructions for implementing a plurality of the project management parameters at the substantially equivalent quality level; and (d) providing training materials based on the implementation plan of step (c). Step (a) may further comprise: providing an assessment questionnaire to collect data on the pre-existing project management status. Step (a) may further comprise: performing a risk analysis of the pre-existing project management status. Additionally, step (a) may further comprise: performing a resource analysis to identify resource usage conflicts.

In one embodiment, step (c) includes instructions for implementing at least one of the project management parameters of: communications management, metrics and reporting management, stakeholder management, and work planning management. In another embodiment, step (c) includes instructions for implementing each of the project management parameters of: communications management, metrics and reporting management, stakeholder management, and work planning management.

After initiation of the implementation plan of step (c), the project management method may further comprise: (e) performing implementation support to ensure continued compliance with the implementation plan of step (c). Step (e) may further comprise: analyzing each project management parameter to determine whether said parameter meets the substantially equivalent quality level. The method may further include (f) adjusting the implementation plan of step (c) if one or more of the project management parameters fail to meet the substantially equivalent quality level; and/or (g) providing training materials based on the adjusted implementation plan of step (f).

In still another embodiment, there is provided a project management method, comprising: (a) performing an initial assessment to determine a pre-existing project management status for a plurality of project management parameters; (b) performing a risk analysis of the pre-existing project management status; (c) establishing a substantially equivalent quality level for the plurality of project management parameters based on the initial assessment of step (a); (d) creating an implementation plan including instructions for implementing the plurality of project management parameters at the substantially equivalent quality level; (e) providing training materials based on the implementation plan of step (d); and (f) performing implementation support to ensure continued compliance with the implementation plan of step (d) by analyzing each of the plurality of project management parameters to determine whether the implementation of each of said plurality of project management parameters meets the substantially equivalent quality level. The project management parameters may be selected from the group consisting of: communications management, financial management, integration management, issue and risk management, metrics and reporting management, resource management, scope and change control management, stakeholder management, tool support management, and work planning management.

In still another embodiment, there is provide a project management computing system, comprising: an input interface, a storage database, and a display unit. The input interface is configured for collecting data on a pre-existing project management status for a plurality of project management parameters. The project management parameters may include: communications management, financial management, integration management, issue and risk management, metrics and reporting management, resource management, scope and change control management, stakeholder management, tool support management, and work planning management.

The storage database is used for maintaining a substantially equivalent quality level for the project management parameters based on an initial assessment of the pre-existing project management status. The storage database is also used for maintaining an implementation plan including instructions for implementing a plurality of the project management parameters at the substantially equivalent quality level. The storage database is also used for maintaining training materials based on the implementation plan. In one embodiment, the storage database includes training materials for at least the project management parameters of: metrics and reporting management, and work planning management. In an alternative embodiment, the storage database includes training materials for each of the project management parameters of: metrics and reporting management, and work planning management.

The display unit is configured for displaying the training materials and/or implementation plan. The training materials may include instructions for implementation of the project management parameters, instructions for customization of the project management parameters, or instructions for use of implementation tools. The implementation plan may include instructions for implementing at least one of the project management parameters of: communications management, metrics and reporting management, stakeholder management, and work planning management.

The input interface may further configured to receive implementation support data corresponding to one or more of the project management parameters. As such, the project management computing system may further comprise an implementation support analysis unit configured to determine whether each project management parameter meets the substantially equivalent quality level. The display unit may be further configured to display an output from the implementation support analysis unit. The display unit may be further configured to display instructions for adjusting the implementation plan if one or more of the project management parameters fail to meet the substantially equivalent quality level.

In another embodiment, there is provided a project management computing system, comprising an input interface for collecting: assessment data on a pre-existing project management status for a plurality of project management parameters; and implementation support data corresponding to one or more of the plurality of project management parameters. The system further comprises a storage database for maintaining: a substantially equivalent quality level for the plurality of project management parameters based on an initial assessment of the pre-existing project management status; an implementation plan including instructions for implementing a plurality of the project management parameters at the substantially equivalent quality level; and training materials based on the implementation plan. The system further comprises: an implementation support analysis unit configured to determine whether each project management parameter meets the substantially equivalent quality level; and a display unit for displaying the training materials, the instructions from the implementation plan, and an output from the implementation support analysis unit.

The plurality of project management parameters may be selected from the group consisting of: communications management, financial management, integration management, issue and risk management, metrics and reporting management, resource management, scope and change control management, stakeholder management, tool support management, and work planning management, and

In still another embodiment, there is provided a project management system comprising means for inputting assessment data for a plurality of project management parameters; means for inputting implementation support data; means for performing an initial assessment to determine a pre-existing project management status for a plurality of project management parameters; means for performing a risk analysis of the pre-existing project management status; means for establishing a substantially equivalent quality level for the plurality of project management parameters based on the initial assessment; means for creating an implementation plan including instructions for implementing the plurality of project management parameters at the substantially equivalent quality level; means for providing training materials based on the implementation plan; and/or means for performing implementation support to ensure continued compliance with the implementation plan by analyzing each of the plurality of project management parameters to determine whether the implementation of each of said plurality of project management parameters meets the substantially equivalent quality level.

### Communication Between Parties Practicing the Present Invention.

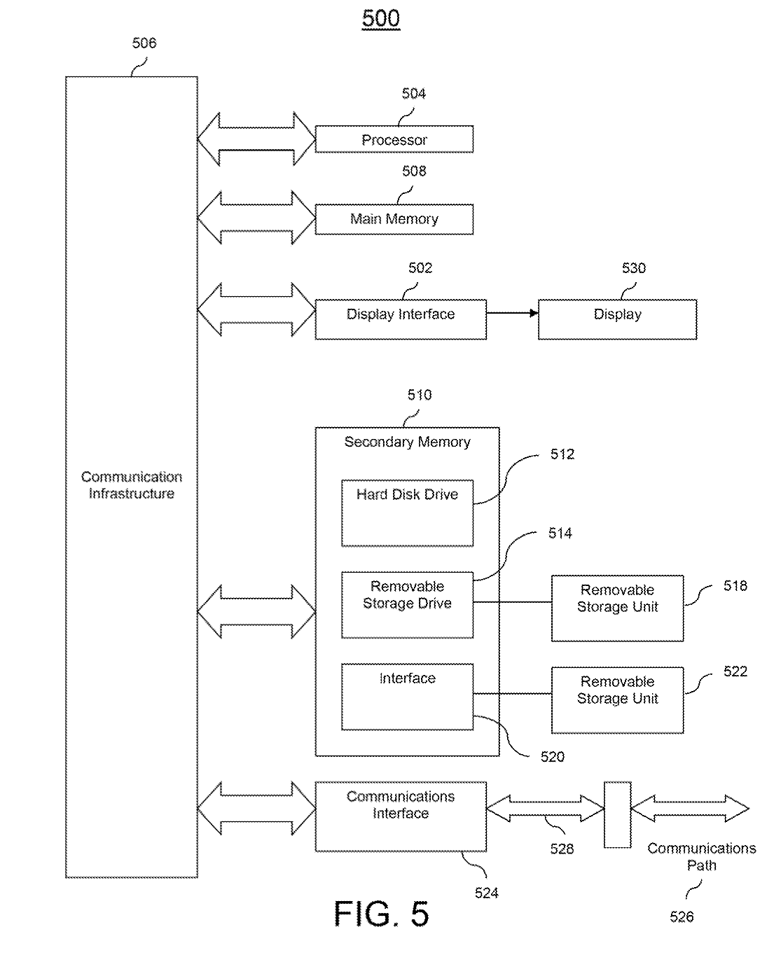

In one embodiment, communication between the various parties and components of the present invention is accomplished over a network consisting of electronic devices connected either physically or wirelessly, wherein digital information is transmitted from one device to another. Such devices (e.g., end-user devices and/or servers) may include, but are not limited to: a desktop computer, a laptop computer, a handheld device or PDA, a cellular telephone, a set top box, an Internet appliance, an Internet TV system, a mobile device or tablet, or systems equivalent thereto. Exemplary networks include a Local Area Network, a Wide Area Network, an organizational intranet, the Internet, or networks equivalent thereto. The functionality and system components of an exemplary computer and network are further explained in conjunction with FIG. 5, below.

### Computer Implementation.

In one embodiment, the invention is directed toward one or more computer systems capable of carrying out the functionality described herein. For example, FIG. 5 is a schematic drawing of a computer system 500 used to implement the methods presented above. Computer system 500 includes one or more processors, such as processor 504. The processor 504 is connected to a communication infrastructure 506 (e.g., a communications bus, cross-over bar, or network). Computer system 500 can include a display interface 502 that forwards graphics, text, and other data from the communication infrastructure 506 (or from a frame buffer not shown) for display on a local or remote display unit 530.

Computer system 500 also includes a main memory 508, such as random access memory (RAM), and may also include a secondary memory 510. The secondary memory 510 may include, for example, a hard disk drive 512 and/or a removable storage drive 514, representing a floppy disk drive, a magnetic tape drive, an optical disk drive, flash memory device, etc. The removable storage drive 514 reads from and/or writes to a removable storage unit 518. Removable storage unit 518 represents a floppy disk, magnetic tape, optical disk, flash memory device, etc., which is read by and written to by removable storage drive 514. As will be appreciated, the removable storage unit 518 includes a computer usable storage medium having stored therein computer software, instructions, and/or data.

In alternative embodiments, secondary memory 510 may include other similar devices for allowing computer programs or other instructions to be loaded into computer system 500. Such devices may include, for example, a removable storage unit 522 and an interface 520. Examples of such may include a program cartridge and cartridge interface (such as that found in video game devices), a removable memory chip (such as an erasable programmable read only memory (EPROM), or programmable read only memory (PROM)) and associated socket, and other removable storage units 522 and interfaces 520, which allow computer software, instructions, and/or data to be transferred from the removable storage unit 522 to computer system 500.

Computer system 500 may also include a communications interface 524. Communications interface 524 allows computer software, instructions, and/or data to be transferred between computer system 500 and external devices. Examples of communications interface 524 may include a modem, a network interface (such as an Ethernet card), a communications port, a Personal Computer Memory Card International Association (PCMCIA) slot and card, etc. Software and data transferred via communications interface 524 are in the form of signals 528 which may be electronic, electromagnetic, optical, or other signals capable of being received by communications interface 524. These signals 528 are provided to communications interface 524 via a communications path (e.g., channel) 526. This channel 526 carries signals 528 and may be implemented using wire or cable, fiber optics, a telephone line, a cellular link, a radio frequency (RF) link, a wireless communication link, and other communications channels.

In this document, the terms “computer-readable storage medium,” “computer program medium,” and “computer usable medium” are used to generally refer to media such as removable storage drive 514, removable storage units 518, 522, data transmitted via communications interface 524, and/or a hard disk installed in hard disk drive 512. These computer program products provide computer software, instructions, and/or data to computer system 500. These computer program products also serve to transform a general purpose computer into a special purpose computer programmed to perform particular functions, pursuant to instructions from the computer program products/software. Embodiments of the present invention are directed to such computer program products.

Computer programs (also referred to as computer control logic) are stored in main memory 508 and/or secondary memory 510. Computer programs may also be received via communications interface 524. Such computer programs, when executed, enable the computer system 500 to perform the features of the present invention, as discussed herein. In particular, the computer programs, when executed, enable the processor 504 to perform the features of the presented methods. Accordingly, such computer programs represent controllers of the computer system 500. Where appropriate, the processor 504, associated components, and equivalent systems and sub-systems thus serve as “means for” performing selected operations and functions. Such “means for” performing selected operations and functions also serve to transform a general purpose computer into a special purpose computer programmed to perform said selected operations and functions.

In an embodiment where the invention is implemented using software, the software may be stored in a computer program product and loaded into computer system 500 using removable storage drive 514, interface 520, hard drive 512, communications interface 524, or equivalents thereof. The control logic (software), when executed by the processor 504, causes the processor 504 to perform the functions and methods described herein.

In another embodiment, the methods are implemented primarily in hardware using, for example, hardware components such as application specific integrated circuits (ASICs). Implementation of the hardware state machine so as to perform the functions and methods described herein will be apparent to persons skilled in the relevant art(s). In yet another embodiment, the methods are implemented using a combination of both hardware and software.

Embodiments of the invention, including any systems and methods described herein, may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact result from computing devices, processors, controllers, or other devices executing firmware, software, routines, instructions, etc.

For example, in one embodiment, there is provided a computer-readable storage medium having instructions, executable by one or more processing device(s), that when executed cause the processing device(s) to: (a) perform an initial assessment to determine a pre-existing project management status for project management parameters, wherein the project management parameters include: communications management, financial management, integration management, issue and risk management, metrics and reporting management, resource management, scope and change control management, stakeholder management, tool support management, and work planning management; (b) establish a substantially equivalent quality level for the project management parameters based on the initial assessment; (c) create an implementation plan including instructions for implementing a plurality of the project management parameters at the substantially equivalent quality level; and (d) provide training materials based on the implementation plan.

In another embodiment, there is provided a computer-readable storage medium having instructions, executable by one or more processing device(s), that when executed cause the processing device(s) to: (a) perform an initial assessment to determine a pre-existing project management status for a plurality of project management parameters, wherein the project management parameters are selected from the group consisting of: communications management, financial management, integration management, issue and risk management, metrics and reporting management, resource management, scope and change control management, stakeholder management, tool support management, and work planning management; (b) perform a risk analysis of the pre-existing project management status; (c) establish a substantially equivalent quality level for the plurality of project management parameters based on the initial assessment; (d) create an implementation plan including instructions for implementing the plurality of project management parameters at the substantially equivalent quality level; (e) provide training materials based on the implementation plan; and (f) perform implementation support to ensure continued compliance with the implementation plan of step (d) by analyzing each of the plurality of project management parameters to determine whether the implementation of each of said plurality of project management parameters meets the substantially equivalent quality level.

### CONCLUSION

The foregoing description of the invention has been presented for purposes of illustration and description. It is not intended to be exhaustive or to limit the invention to the precise form disclosed. Other modifications and variations may be possible in light of the above teachings. The embodiments were chosen and described in order to best explain the principles of the invention and its practical application, and to thereby enable others skilled in the art to best utilize the invention in various embodiments and various modifications as are suited to the particular use contemplated. It is intended that the appended claims be construed to include other alternative embodiments of the invention; including equivalent structures, components, methods, and means.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

It is to be appreciated that the Detailed Description section, and not the Summary and Abstract sections, is intended to be used to interpret the claims. The Summary and Abstract sections may set forth one or more, but not all exemplary embodiments of the present invention as contemplated by the inventor(s), and thus, are not intended to limit the present invention and the appended claims in any way.

What is claimed is:

1. A project management method, comprising:
(a) performing an initial assessment to determine a pre-existing project management status for project management parameters, wherein the project management parameters include:
communications management, financial management, integration management, issue and risk management, metrics and reporting management, resource management, scope and change control management, stakeholder management, tool support management, and work planning management;
(b) establishing a substantially equivalent quality level for the project management parameters based on the initial assessment;
(c) creating an implementation plan including instructions for implementing a plurality of the project management parameters at the substantially equivalent quality level; and
(d) providing training materials based on the implementation plan of step (c).

2. The method of claim 1, wherein step (a) further comprises:
providing an assessment questionnaire to collect data on the pre-existing project management status.

3. The method of claim 1, wherein step (a) further comprises:
performing a risk analysis of the pre-existing project management status.

4. The method of claim 1, wherein step (a) further comprises:
performing a resource analysis to identify resource usage conflicts.

5. The method of claim 1, wherein step (c) includes instructions for implementing at least one of the project management parameters of: communications management, metrics and reporting management, stakeholder management, and work planning management.

6. The method of claim 1, wherein after initiation of the implementation plan of step (c), the project management method further comprises:
(e) performing implementation support to ensure continued compliance with the implementation plan of step (c).

7. The method of claim 6, wherein step (e) further comprises:
analyzing each project management parameter to determine whether said parameter meets the substantially equivalent quality level.

8. The method of claim 7, further comprising:
(f) adjusting the implementation plan of step (c) if one or more of the project management parameters fail to meet the substantially equivalent quality level.

9. The method of claim 8, further comprising:
(g) providing training materials based on the adjusted implementation plan of step (f).

10. A project management method, comprising:
(a) performing an initial assessment to determine a pre-existing project management status for a plurality of project management parameters, wherein the project management parameters are selected from the group consisting of: communications management, financial management, integration management, issue and risk management, metrics and reporting management, resource management, scope and change control management, stakeholder management, tool support management, and work planning management;
(b) performing a risk analysis of the pre-existing project management status;
(c) establishing a substantially equivalent quality level for the plurality of project management parameters based on the initial assessment of step (a);
(d) creating an implementation plan including instructions for implementing the plurality of project management parameters at the substantially equivalent quality level;
(e) providing training materials based on the implementation plan of step (d); and
(f) performing implementation support to ensure continued compliance with the implementation plan of step (d) by analyzing each of the plurality of project management parameters to determine whether the implementation of each of said plurality of project management parameters meets the substantially equivalent quality level.

11. A project management computing system, comprising:
an input interface for collecting data on a pre-existing project management status for a plurality of project management parameters, wherein the project management parameters include: communications management, financial management, integration management, issue and risk management, metrics and reporting management, resource management, scope and change control management, stakeholder management, tool support management, and work planning management;
a storage database for maintaining
a substantially equivalent quality level for the project management parameters based on an initial assessment of the pre-existing project management status,
an implementation plan including instructions for implementing a plurality of the project management parameters at the substantially equivalent quality level, and
training materials based on the implementation plan; and
a display unit for displaying the training materials.

12. The project management computing system of claim 11, wherein the storage database includes training materials for at least the project management parameters of: metrics and reporting management, and work planning management.

13. The project management computing system of claim 11, wherein the training materials include instructions for implementation of the project management parameters, instructions for customization of the project management parameters, or instructions for use of implementation tools.

14. The project management computing system of claim 11, wherein the implementation plan includes instructions for implementing at least one of the project management parameters of: communications management, metrics and reporting management, stakeholder management, and work planning management.

15. The project management computing system of claim 11, wherein the input interface is further configured to receive implementation support data corresponding to one or more of the project management parameters.

16. The project management computing system of claim 11, further comprising:
an implementation support analysis unit configured to determine whether each project management parameter meets the substantially equivalent quality level.

17. The project management computing system of claim 16, wherein the display unit is further configured to display an output from the implementation support analysis unit.

18. The project management computing system of claim 17, wherein the display unit is further configured to display instructions for adjusting the implementation plan if one or more of the project management parameters fail to meet the substantially equivalent quality level.

19. A project management computing system, comprising:
an input interface for collecting
assessment data on a pre-existing project management status for a plurality of project management parameters, wherein the plurality of project management parameters are selected from the group consisting of: communications management, financial management, integration management, issue and risk management, metrics and reporting management, resource management, scope and change control management, stakeholder management, tool support management, and work planning management, and
implementation support data corresponding to one or more of the plurality of project management parameters;
a storage database for maintaining
a substantially equivalent quality level for the plurality of project management parameters based on an initial assessment of the pre-existing project management status,
an implementation plan including instructions for implementing a plurality of the project management parameters at the substantially equivalent quality level, and
training materials based on the implementation plan;
an implementation support analysis unit configured to determine whether each project management parameter meets the substantially equivalent quality level; and
a display unit for displaying the training materials, the instructions from the implementation plan, and an output from the implementation support analysis unit.
